(19) United States
(12) Patent Application Publication
(10) Pub. No.: US 2012/0123803 A1
(43) Pub. Date: May 17, 2012

(54) Method and System for Transforming Patient Care

(75) Inventors: Mark W. Kovacik, Akron, OH (US); Donald A. Noe, Akron, OH (US)

(73) Assignee: Summa Health System, Akron, OH (US)

(21) Appl. No.: 13/298,721

(22) Filed: Nov. 17, 2011

Related U.S. Application Data
(60) Provisional application No. 61/414,656, filed on Nov. 17, 2010.

(51) Int. Cl. G06Q 50/24

(52) U.S. Cl. 705/3

(57) ABSTRACT

A method and system of transforming patient care including a multi-disciplinary strategy consisting of the adoption of a “code” alert used to mobilize and coordinate all treatment caregivers, improve regional paramedic education, and a database to track the progress of a patient as they move through the emergency medical system is described. In an effort to reduce the elapsed time from when the patient first encounters medical providers to the time of treatment, the time intervals during a patient's treatment travel are tracked and analyzed to highlight areas that need to be improved upon.

### BACKGROUND

This application claims the benefit of U.S. Provisional Application No. 61/414,656 filed Nov. 17, 2010.

Tracking the progress of a patient as they move from the responsibility of the emergency medical services (EMS) personnel to the doctors in the hospital is critical to improving the patient's care. Currently, most health care providers rely on pen-and-paper forms which may be later entered into a computer system to generate statistics for procedure review. While there may be medical information systems in use throughout the healthcare community, none are focused specifically on transforming patient care by decreasing the amount of time that it takes to get the patient from the care of the (EMS) personnel, or from the Hospital Emergency Department (for walk-in patients) to percutaneous interventions associated with, but not limited to, Trauma, Stroke or a Myocardial Infarction.

### BRIEF SUMMARY

A specific example in which patient care has been significantly transformed is for patients experiencing a ST segment Elevation Myocardial Infarction (STEMI), more commonly known as a heart attack. This is a condition in which a plaque formation within the coronary artery has completely blocked the flow of blood to the downstream heart muscle, causing significant heart muscle damage, a loss of heart function, and often patient death. Recognizing that prompt percutaneous intervention for patients in a STEMI situation can significantly reduce the mortality and morbidity rate, the American College of Cardiology/American Heart Association (ACC/AHA) has recently reduced the recommended time to treatment guideline from 120 to 90 minutes. A multi-disciplinary strategy consisting of the adoption of a “code” alert used to mobilize and coordinate all treatment caregivers, improved regional paramedic education and a database to track the progress of a patient as they move through the emergency medical system, has shown to transform a patient's care. In an effort to reduce the elapsed time from when the patient enters the hospital Emergency Department to the time of reperfusion of the coronary artery, a time interval otherwise known as the door-to-balloon (D2B) time, a STEMI patient tracking software was developed. The STEMI data tracker software has had a significant impact on identifying and expediting the various treatment disciplines such as in-the-field or hospital electrocardiograms (EKGs), total Emergency Room time, activation of the code STEMI alert, and catherization laboratory staff arrival. After implementation of this STEMI data tracker software and a multi-disciplinary strategy at one local hospital, 96% of presented STEMI patients now meet the 90 minute treatment deadline. The STEMI Data Tracker software allows the user to enter key time parameters associated with a patient's care, from initial contact to the time of having their occluded coronary artery opened to reestablish the blood flow. These time points are used to calculate the time intervals during the patient's treatment travel. Using the software system, the time intervals may be presented both graphically as well as numerically. The cases can be analyzed in whole or in parts to allow the opportunity to see which portion of the patient's treatment travel needs to be improved in order to meet the ACC/AHA guidelines. With this system, the elapsed time from when the Emergency medical services first make contact with the patient to the time of reperfusion of the coronary artery, otherwise known as the E2B time, has also been improved such that 73% of the presented STEMI E2B times have met the 90 minute treatment deadline.

The accompanying drawings, which are incorporated in and constitute a part of the specification, illustrate various example systems, methods, and so on that illustrates various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### DESCRIPTION OF DRAWINGS

FIG. 1 is an exemplary screen in an embodiment of a tracking system.

FIG. 2 is an exemplary screen in an embodiment of a tracking system.

FIG. 3 is an exemplary screen in an embodiment of a tracking system.

FIG. 4 is an exemplary screen in an embodiment of a tracking system.

FIG. 5 is an exemplary screen in an embodiment of a tracking system.

FIG. 6 is a flowchart of an exemplary process to improve patient care.

FIG. 7 is a flowchart of an exemplary process to improve patient care.

FIG. 8 is a chart of experimental data.

FIG. 9 is a chart of experimental data.

FIG. 10 is a flowchart of a process to improve patient care.

### DETAILED DESCRIPTION

The system user enters key time parameters associated with a patient's care, from their initial contact, either with the emergency medical service (EMS) or hospital emergency department if the patient walks in, to the time of having the appropriate procedure performed. These time points are used to calculate the time intervals during the patient's treatment travel. Such a system may be hosted on a dedicated computer system, or distributed over a network including the internet.

When the system is implemented as a computer program, a log on screen may appear. A case sensitive password can be used to allow access to the input form to prevent unauthorized entry into the database. The password may include text, biometric, authentication card and other known methods to restrict access to computerized systems. Individual log-ins may also be tracked along with records created or modified during a logged in session. In one example, a password or log-in may be time stamped and only work for a period of time set by an administrator. An option to set the password or login for an indefinite time period may also be available. In one embodiment, the password is stored in a separate “.dat” file different from the database file. A user may be allowed a limited number of unsuccessful log-in attempts before the program will cease to function.

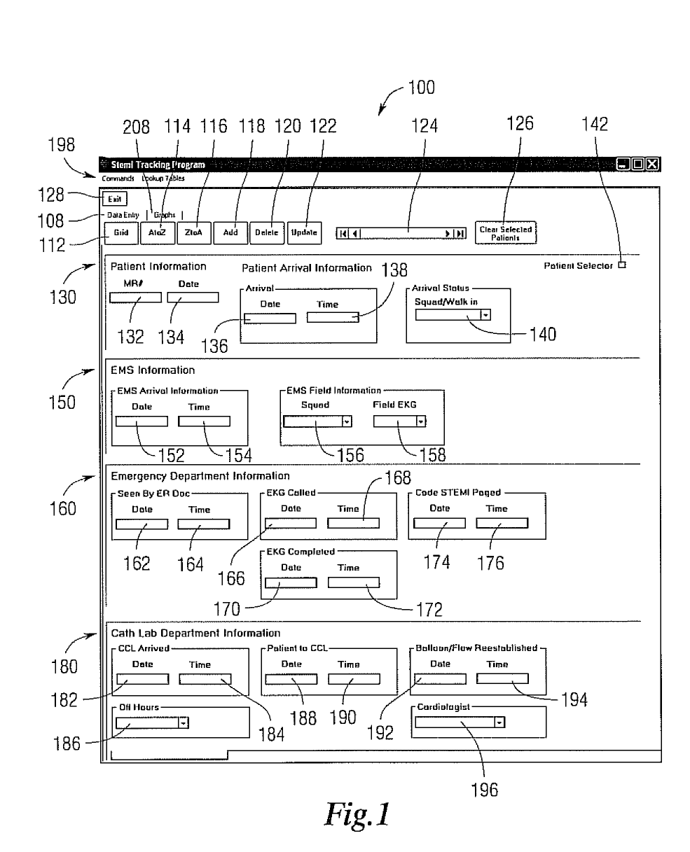

An exemplary screen or form view, 100, in the system when the data entry tab, 108, is chosen, is shown in FIG. 1. The exemplary screen described here is used to track data for patients that have had a heart attack or were in a segment elevation myocardial infarction (STEM) situation but can be used to track any event. It should be noted that this is just one use of the system. Typically a STEMI situation is determined by the results of an EKG (electrocardiogram). A button bar is along the top of the screen allowing the user options for entering and editing the data. The grid button, 112, allows the user to change from form view, shown, to grid view, not shown. The grid view is a spreadsheet type format. The A to Z button, 114, alphabetizes the field selected in ascending order whereas the Z to A button, 116, alphabetizes the field selected in descending order. Button, 118, the add button, creates an empty record so new data can be entered into the database. The delete button, 120, deletes the current record. A message box will pop up asking the user if he is sure he wishes to delete the record. If the “yes” button is selected, the record will be permanently erased from the database. If the “no” button is selected, the program will continue and no records will be erased. The update button, 122, updates the current record. The records bar, 124, is used to step through the records in the database. It allows the user to see which record is currently being accessed and how many are in the database. Clear selected patients, button 126, clears all patients that have been selected by using field, 142. The exit button, 128, allows the user to exit the system.

Section, 130, permits viewing or entry of patient information. The first text box, 132, is the medical record number (MR#) or patient identifier for alpha-numeric entries. Text box, 134, is the date field and represents the date in which the emergency event occurred. When data for a new patient is being added, a message box will pop up allowing the user the option to set all dates on the screen to the entered date. If “yes” is selected, all of the date fields will be given the same entered date. If “no” is selected, then the program will just move to the next field. The fields for the patient arrival information represent the date, 136, and time, 138, that the patient arrived at the hospital. Arrival status, such as “squad” or “walk-in” are indicated at the editable, dropdown menu, 140, and represents the mode is which the patient was brought to the hospital. The choices for the box, 140, are up to the user. If the user types in an option that is not present when using the dropdown arrow, the typed in option will be saved and available for selection the next time the menu is selected. The small patient selector box, 142, allows the user to select one or more patients that is of specific interest. When more than one patient is selected, a subgroup is formed containing the selected patients. An individual patient can be cleared from the subgroup by un-checking the patient selector box, 142, or the entire group can be cleared by clicking the clear selected patients button, 126.

Another section is for the emergency medical service (EMS) information, 150. The date. 152, and time, 154, fields represent the date and time the EMS arrived at the scene of the patient. The EMS field information is represented by an editable dropdown menu, 156, which indicates which squad brought the patient to the emergency room (ED). Like menu 140, user entry may be free-field typed or selected from a prepopulated list where typed options are saved and added to the list for the next record. The field EKG box, 158, allows the user to indicate either “yes” or “no,” using the dropdown arrows, as to whether or not the patient had an EKG performed in the field prior to arrival at the hospital. Box 158 may be modified to track other medical procedures.

Section 160 on the screen is where the hospital emergency department information is entered. Boxes 162 and 164, are the date and time, respectively, for when the patient was seen by the ED doctor. Boxes 166 and 168, indicate the time and date, respectively, that the EKG was called for, and boxes 170 and 172, represent the time and date, respectively, that the EKG was completed. Calling a “code” can mean, for example, that the patient is in a STEMI situation and the medical personnel are dispatched to the catheterization laboratory (cath lab) to prepare for arrival of the patient. The catheterization laboratory is where the patient is treated and the blocked artery is cleared, for example via, balloon angioplasty. If the event happens off hours on a holiday or week-end, the response time may be increased. Section 180, specifically written for STEMI situations, represents the data for the catheterization laboratory. Boxes 182 and 184 represent the date and time, respectively that the catheterization laboratory personnel arrived. The off hours box, 186, has a drop down option that allows the user to indicate “yes” or “no” for whether or not the incident happened during off hours. Boxes, 188 and 190, are the date and time, respectively, that the patient arrived in the catheterization laboratory. Boxes, 192 and 194, indicate the date and time, respectively, that flow through the blocked artery was restored. Finally, box 196 has a drop down function that allows the user to identify personnel, such as the cardiologist that performed the balloon angioplasty.

In addition to the fields already described, potential menu options, such as commands and lookup tables, are shown along the top menu bar, 198.

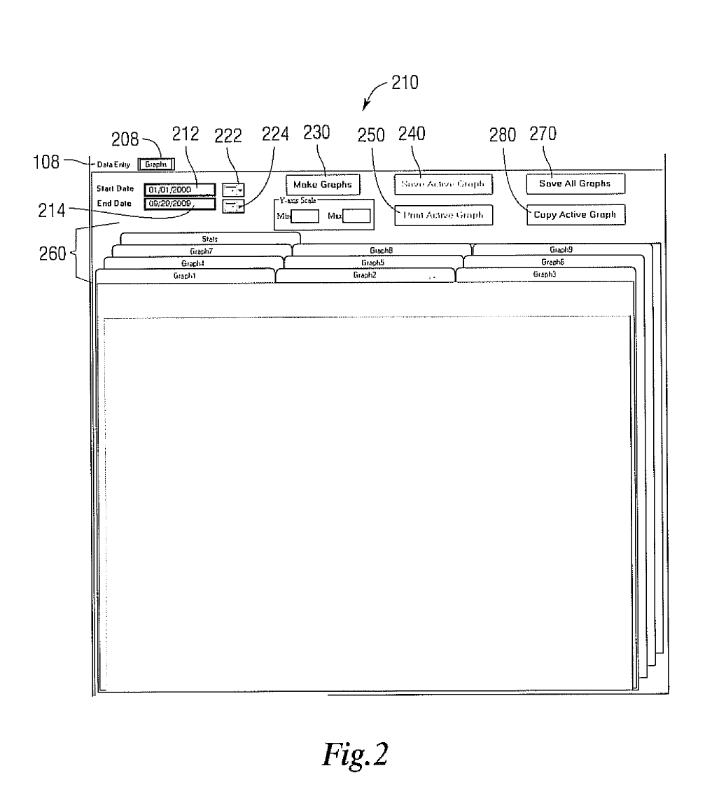

An alternate view is shown in FIG. 2. When the graphs tab, 208 (FIG. 1) is chosen then an alternate screen or form view, 210, is displayed. In order to graph/analyze data, the start date, box 212, and the end date, box 214, may be set for the desired time frame. As a default, the entire database may be analyzed. The dates can be typed in directly or selected by clicking the calendar icon(s), 222 and/or 224, next to the date box causing a pop-up calendar to appear.

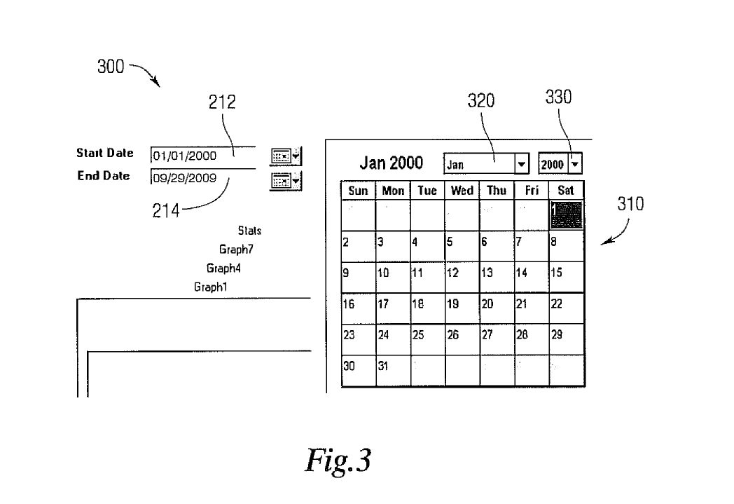

With reference now to FIG. 3, a pop-up calendar selector 310 is shown. The user may then choose the desired date by moving across the calendar screen and clicking on it. The desired month is selected in the dropdown box, 320, and the desired year is chosen in dropdown box 330.

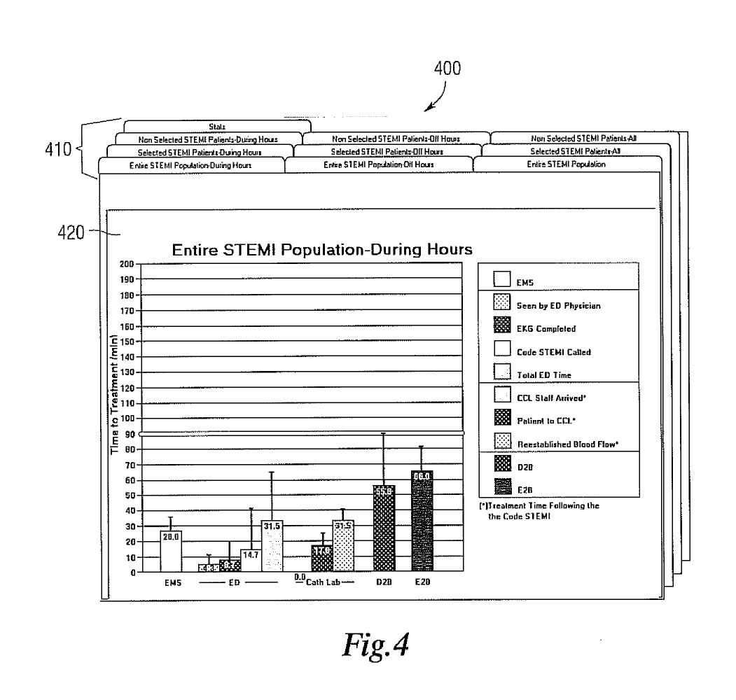

Once the dates are set, a make graphs button, 230 (FIG. 2), may be selected to create graphs, such as the screen shown in FIG. 4. This screen is set up specifically for tracking STEMI data; however, it could be altered for any type of medical procedure. Pre-labeled tabs are shown at 410. Tabs for Non Selected STEMI Patients-During Flours, Selected STEMI Patients-During Hours, Entire STEMI Population-During Hours, Non Selected STEMI Patients-Off Hours, Selected STEMI Patients-Off Hours, Entire STEMI Population-Off Hours, Non Selected STEMI Patients-All, Selected STEMI Patients-All, and Entire STEMI Population are shown. Clicking on a specific tab, for example, Entire STEMI Population-During Hours, creates and displays a bar graph such as that shown at 420. In this case, the amount of time the patient spent with the emergency medical services (EMS) 28 minutes, total time in the hospital emergency department, 31.5 minutes, including time with the doctor, 4.3 minutes, time until EKG was completed, 8.7 minutes, and time until the “code” was called, 14.7 minutes, and time in the catheterization laboratory including 17.8 minutes treatment time once the “code” was called and 31.5 minutes to reestablish blood flow is shown. In addition, the D2B time (the time interval from when the patient enters the hospital emergency department until flow is resumed in the artery) as well as the E2B time (time interval from when the EMS personnel first make contact with the patient until flow is resumed in the artery) is shown.

Referring back to FIG. 2, the save active graph button 240, allows the user to save the active graph. The print active graph button 250, allows the user to print the active graph. Each time a graph is saved, a tab is created for that graph and numbered sequentially. Exemplary graph tabs are shown at 260. Save all graphs button 270 allows all of the graphs to be saved, and copy active graph button 280 allows for the copying of the active graph to the clipboard so that the image can be pasted into another document.

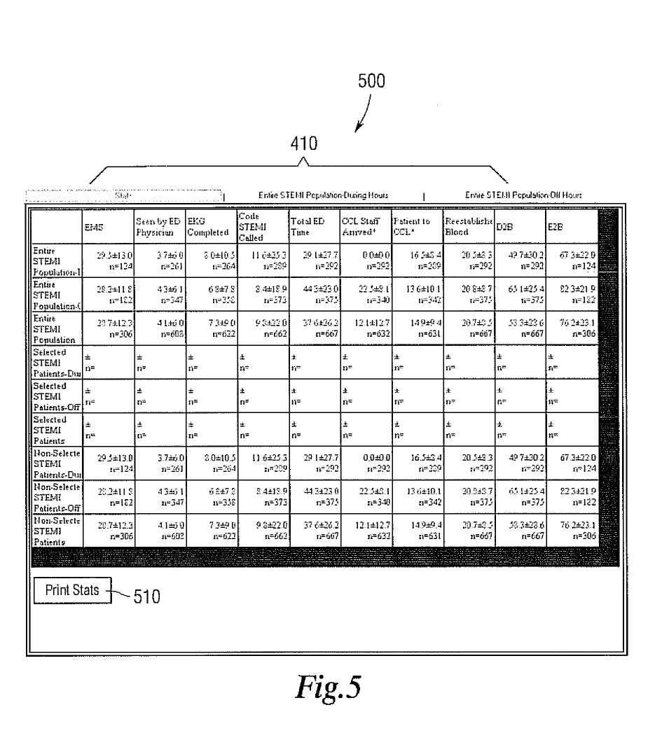

With reference now to FIG. 5, an exemplary spreadsheet 500 is shown (displayed as average, standard deviation and count). The spreadsheet 500 may include the amount of time spent with the EMS personnel, time being seen by an ED doctor, time until the EKG is completed, time until “code” was called, total time in the emergency room, time until catheterization laboratory staff arrived, time until patient arrived and was treated in the catheterization laboratory, time until blood flow through the blocked artery was reestablished, D2B time, and E2B time. The sheet 500 may be sorted by any variety of column or row including Non Selected STEMI Patients-During Hours, Selected STEMI Patients-During Hours, Entire STEMI Population-During Hours, Non Selected STEMI Patients-Off Hours, Selected STEMI Patients-Off Hours, Entire STEMI Population-Off Flours, Non Selected STEMI Patients-All, Selected STEMI Patients-All, and Entire STEMI Population. Button 510 allows the user to print the spreadsheet.

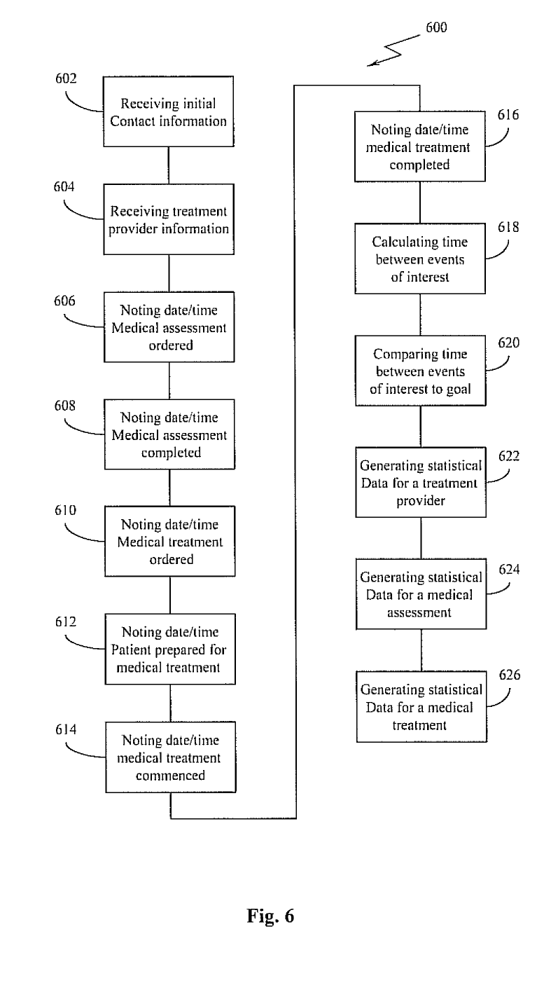

Referring now to FIG. 6, a process, 600, illustrates one example of a computer-implemented method of improving healthcare treatment times for a patient. The method may be initiated by receiving initial contact information for a patient, 602. The information may include date, time, location, geographical information, patient identification data, vital signs and/or other initial data corresponding to the patient's initial contact with a treatment facility. It is to be appreciated that the treatment facility may include a hospital admissions area, an emergency department, clinic, Emergency Medical Service personnel or other first responders arriving on an accident scene and the like. The method may continue by receiving treatment provider information, 609. The treatment provider information may include identifying information corresponding to a physician, nurse, technician or team of providers who encounter the patient for assessment. The treatment provider information may additionally include date, time, location, geographical information, patient identification data, vital signs and/or other data corresponding to or derived from the treatment provider's encounter with the patient. The method may also take note of date and time a medical assessment, such as an x-ray, MRI, CT scan, EKG, EEG and the like, was ordered, 606, and when the assessment was completed, 608. The method may also take note of date and time that medical treatment, such as sutures, cast, surgery, medication and the like, was ordered, 610, and the date and time information that the patient was ready for treatment, 612, such readiness including transporting to the treatment room or facility. The method may also note the date and time that the medical treatment was commenced, 614, and completed, 616.

In one embodiment, the various data collected may be manually entered by administrative personnel, for example during the intake process, or automated. For example, information may be automatically “ported” from electronic medical record entries, internal calendar/clock applications, proximity or wireless identification devices uniquely associated with treatment providers, treatment rooms, or the patient, and other automated systems.

Continuing with reference to FIG. 6, the computer-implemented method may additionally execute a calculation algorithm to assess actual times required for certain tasks, 618. For example, in STEMI situations, lowering the D2B and/or the E2B times are important to patient success, so the method may be requested to calculate the time between a patient's arrival at the emergency department and subsequent completion of the balloon angioplasty medical treatment. The calculation algorithm may additionally compare the calculated actual times against a standard or goal, 620. Again, in STEMI situations, the American College of Cardiology/American Heart Association (ACC/AHA) has recommended time to treatment guideline from 120 to 90 minutes. In other situations, the medical providers may be encouraged to reduce treatment times to improve OR usage, reduce patient wait times, or times under anesthesia.

After a period of time, the method may execute a statistical analysis algorithm to analyze treatment times for similar treatments over a plurality of treatment providers, 622; or for a set of medical assessment procedures, 624, for example all of a selected assessment procedure organization-wide over a particular time period; or for a set of medical treatments 626, for example all of a selected treatment during a time period.

### Experimental Results

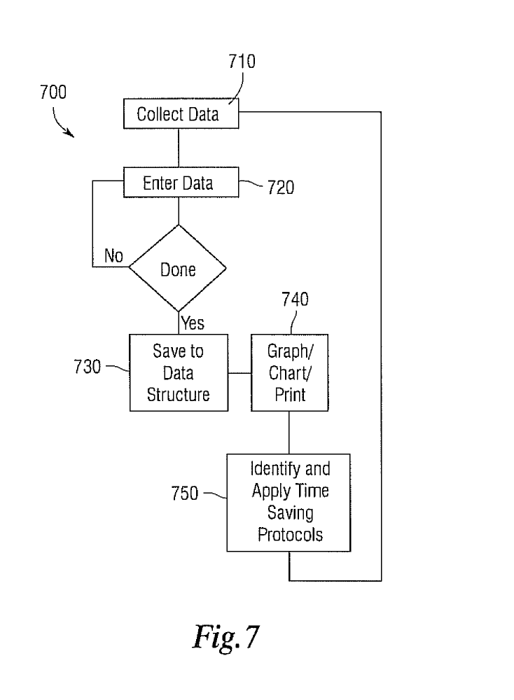

Referring to FIG. 7, a process 700 to improve patient care is shown. An operator collects data pertaining to recent STEMI activities, be it daily, weekly or any other interval, step 710. For each patient, data is entered into a tracking system, step 720, such as that described in connection with FIG. 1 above, although the relevant data could alternatively be entered into a manual tracking system, ledger and the like. After the user has entered or collected all the relevant data, it may be saved into a data structure, 730, with previously saved data. The user may then have the option to analyze the entire data structure or selected records within the data. If the user chooses to analyze, then the user will be able to create reports, graph selected data, chart the data or prepare output for printing, display a distribution, step 740. A principal physician or administrator may review the analysis and meet with STEMI team members on ways to reduce time in specific areas or under certain conditions. Following implementation of new protocols, new data may be collected starting the process anew.

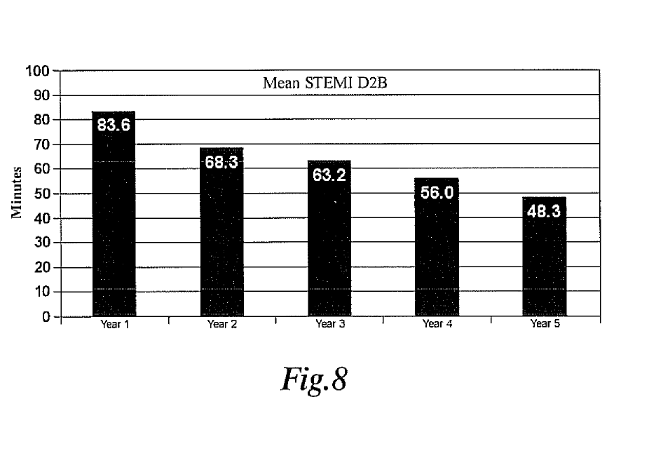

Referring to FIG. 8, exemplary mean STEMI D2B times for a test facility are shown in minutes over several experimental years. In year 1 prior to or at the beginning of implementing the process, the mean D2B was 83.6 minutes. In year 5, the mean D2B is 48.3 minutes. An over 40% reduction in time was seen after implementing the multi-disciplinary strategy which included using the system, using the “code” alert and improving regional paramedic training. In year 2, the system has enabled feedback and changed protocols to greatly reduce the amount of time it takes a patient to receive critical life saving treatment in a STEMI situation thus improving patient care and decreasing mortality rates.

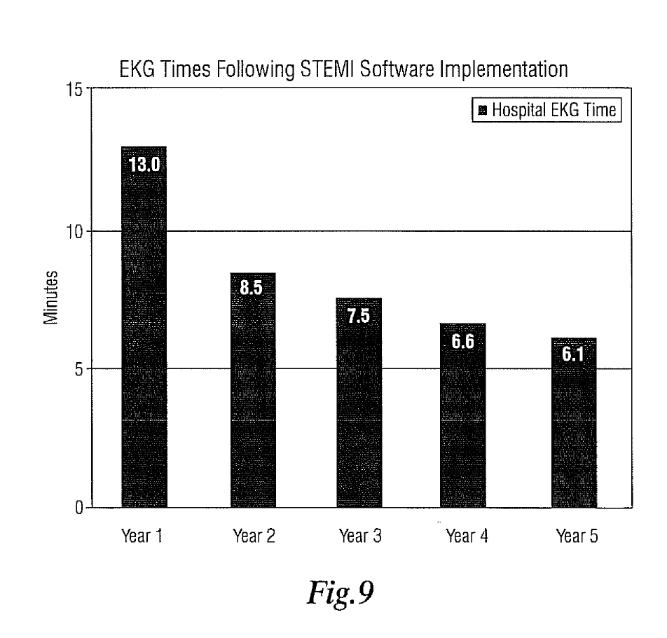

Referring to FIG. 9, the amount of time in minutes until an EKG was performed on a potential STEMI patient is shown for the years between year 2 and year 5. Before implementing the system, in the first half of year 2, it took 13 minutes on average from initial contact to the patient receiving an EKG. However after implementation of a first generation system in the second half of year 2, for experimental purposes, the times steadily decreased, to a low of 6.1 minutes in year 5. The time in identifying or confirming that a patient is having a STEMI has been significantly improved with the implementation of the system.

### Prophetic Example

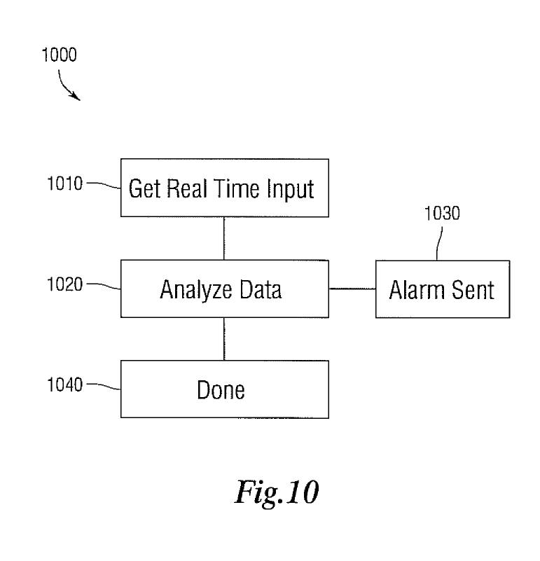

Referring to FIG. 10, a process, 1000, to improve patient care is shown. Data is gathered real-time as the incident is occurring and is automatically entered into the system step 1010. Time, date, location, patient ID and the like, may be scanned, bar-coded, transmitted via RFID or other tracking sub-system to ensure accuracy and timely data recordation. As the data enters into the system, it is analyzed in real time or near real time against a protocol, step 1020. The system may be programmed to allow for a certain amount of time, for example 90 minutes, for the patient to have the appropriate sub-procedure or procedure, such as a balloon angioplasty performed. If the sub-procedure or procedure has not been completed within the allotted time, an alarm will be sent, step 1030. However, if the procedure is performed within the allotted time, then the process is complete, step 1040, and the process starts again at step 1010, for the next patient.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

As used herein, “connection” or “connected” means both directly, that is, without other intervening elements or components, and indirectly, that is, with another component or components arranged between the items identified or described as being connected. To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Similarly, when the applicants intend to indicate “one and only one” of A, B, or C, the applicants will employ the phrase “one and only one”. Thus, use of the term “or” herein is the inclusive, and not the exclusive use. See, Bryan A. Garner, A Dictionary of Modern Legal Usage 624 (2d. Ed. 1995).

1. A computer-implemented method of improving healthcare treatment times for a patient comprising:
Receiving initial patient contact information including a date and time of an initial patient contact with a treatment facility;
Receiving physician information including date and time that a physician first evaluated the patient and a physician identifier;
Calculating EKG information including a length of time between when an EKG was ordered for the patient and when the EKG was completed;
Calculating catheterization information including a length of time between when catheterization was ordered for the patient and when the catheterization was completed;
Calculating a time between the date and time of the initial patient contact and when the catheterization was completed;
Comparing the calculated time to a predefined goal; and
Highlighting a record corresponding to a patient where the calculated time exceeds the predefined goal.

2. The computer-implemented method of improving healthcare treatment times as set forth in claim 1, further comprising:
Implementing a computer-implemented analysis of times between events for a plurality of patients; and
Establishing goals based on statistical results of the computer-implemented analysis.

3. The computer-implemented method of improving healthcare treatment times as set forth in claim 1, further comprising implementing a computer-implemented analysis of times for discrete phases of treatment and a treatment provider for a plurality of patients.

4. The computer-implemented method of improving healthcare treatment times as set forth in claim 3, further comprising identifying select patient from the plurality of patients where the treatment provider exceeded a threshold time.

5. The computer-implemented method of improving healthcare treatment times as set forth in claim 1, further comprising identifying arrival status of a patient including identification of a transporting emergency medical service (EMS) provider.

6. The computer-implemented method of improving healthcare treatment times as set forth in claim 1, further comprising creating a graphical representation of times required for discrete phases of treatment over a selected range of interest.

7. The computer-implemented method of improving healthcare treatment times as set forth in claim 6, where the selected range of interest comprises a calendar period.

8. The computer-implemented method of improving healthcare treatment times as set forth in claim 6, where the selected range of interest comprises a set of patients treated by a particular treatment provider.

9. The computer-implemented method of improving healthcare treatment times as set forth in claim 6, where the selected range of interest comprises a set of patients transported by a particular treatment emergency medical service (EMS) provider.

10. The computer-implemented method of improving healthcare treatment times as set forth in claim 6, where the selected range of interest comprises the time between the date and time of the initial patient contact and when the catheterization was completed.

11. A computer-implemented method of improving healthcare treatment times for a patient comprising:
Receiving initial patient contact information including a date and time of an initial patient contact with a treatment facility;
Receiving treatment provider information including date and time that a treatment provider first evaluated the patient and identifying information of the treatment provider;
Calculating assessment information including a length of time between when an assessment service was ordered for the patient and when the assessment service was completed;
Calculating treatment service information including a length of time between when a treatment service was ordered for the patient and when the treatment service was completed;
Calculating a time between the date and time of the initial patient contact and when the treatment service was completed;
Comparing the calculated time to a predefined goal; and
Highlighting a record corresponding to a patient where the calculated time exceeds the predefined goal.

12. The computer-implemented method of improving healthcare treatment times as set forth in claim 11, further comprising:
Implementing a computer-implemented analysis of times between events for a plurality of patients; and
Establishing goals based on statistical results of the computer-implemented analysis.

13. The computer-implemented method of improving healthcare treatment times as set forth in claim 11, further comprising implementing a computer-implemented analysis of times for discrete phases of treatment and a treatment provider for a plurality of patients.

14. The computer-implemented method of improving healthcare treatment times as set forth in claim 13, further comprising identifying a select patient from the plurality of patients where the treatment provider exceeded a threshold time.

15. The computer-implemented method of improving healthcare treatment times as set forth in claim 11, further comprising identifying arrival status of a patient including identification of a transporting emergency medical service (EMS) provider.
